(19) United States
(12) Patent Application Publication
(10) Pub. No.: US 2013/0257522 A1
(43) Pub. Date: Oct. 3, 2013

(54) HIGH INPUT VOLTAGE CHARGE PUMP

(71) Applicants: Tyler Daigle, Portland, ME (US); Julie Lynn Stultz, Scarborough, ME (US)

(72) Inventors: Tyler Daigle, Portland, ME (US); Julie Lynn Stultz, Scarborough, ME (US)

(21) Appl. No.: 13/435,937

(22) Filed: Mar. 30, 2012

(51) Int. Cl. G05F 3/02

(52) U.S. Cl. 327/536

(57) ABSTRACT

This document discusses, among other things, a charge pump circuit that includes an input, an output, a plurality of field effect transistors (FETs), each of the plurality FETs having a respective gate terminal, and at least two flying capacitors in electrical communication with at least one of the plurality of FETs. Each of the respective gate terminals is configured to receive a respective logic level shifted clock signal voltage. The at least two flying capacitors are configured to alternatingly charge and discharge in response to the logic level shifted clock signal voltages, and the at least two flying capacitors are configured to supply a voltage at the output that is different from a voltage at the input.

### BACKGROUND

Charge pump circuits (or “charge pumps”) are used to convert an input voltage at a first voltage level to an output voltage at a second voltage level. Charge pumps are capable of efficient operation and can be used to generate either a higher output voltage (a positive charge pump) or a lower output voltage (a negative charge pump) from an input voltage. In certain example configurations, a charge pump can include one or more capacitors, referred to in this disclosure as “flying” capacitors, that alternatingly charge and discharge in order to transfer charge from an input of the charge pump to an output of the charge pump.

### OVERVIEW

This document discusses, among other things, a charge pump circuit comprising an input, an output, a plurality of field effect transistors (FETs), each of the plurality FETs having a respective gate terminal, and two or more flying capacitors in electrical communication with at least one of the plurality of FETs. Each of the respective gate terminals is configured to receive a respective logic level shifted clock signal voltage. The two or more flying capacitors are configured to alternatingly charge and discharge in response to the logic level shifted clock signal voltages and to supply a voltage at the output that is different from a voltage at the input.

This section is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a circuit diagram illustrating an example Thevénin equivalent model of a charge pump.

FIG. 2 is a circuit diagram illustrating an example charge pump in accordance with various techniques of this disclosure.

FIGS. 3A-3E are circuit diagrams illustrating example circuits that are used to dynamically shift the logic level of a clock signal, in accordance with various techniques of this disclosure.

FIGS. 4A-4E depict various example logic level shifted clock signals generated by the example circuits depicted in FIGS. 3A-3E.

### DETAILED DESCRIPTION

In general, this disclosure describes techniques that may allow a charge pump to operate at a high input supply voltage while using low voltage field effect transistor (FET) gates and low voltage flying capacitors. In addition, these techniques may provide the charge pump with sufficient current drive capability to power additional circuitry.

Solutions exist that allow a charge pump to operate using a high input supply voltage, e.g., voltages above about 7 volts (V). For example, U.S. Pat. No. 6,995,602 to Pelliconi describes a charge pump system that could be configured to operate using a high input supply voltage. However, in order for the charge pump system of Pelliconi to be configured to operate at high input supply voltages, significant modifications would be required. More particularly, the Pelliconi charge pump circuit would require the use of high voltage flying capacitors, or the use of FETs with high voltage gates if a high input supply voltage level peak-to-peak clock was used. Each of these two options has disadvantages.

High voltage flying capacitors are generally not desirable because they can take up about ten times as much die area when compared to low voltage flying capacitors. Adding die area to accommodate the high input voltage further increases the size and expense of the device.

High voltage gates generally require additional masks, for example, that may not already be available in the circuit design. In addition, some FETs, e.g., complimentary metal-oxide-semiconductor (CMOS) FETs, with high voltage gates may have a high drain-source ON resistance (R_{DS(ON)}) that can decrease the output voltage of the charge pump, thereby reducing the efficiency of the charge pump.

The present inventors have recognized, among other things, that by applying separate logic level shifted clock signals to each gate in a charge pump, the charge pump can operate using a high input supply voltage while also using low voltage FETs and low voltage flying capacitors. Using separate logic level shifted clock signals, the charge pump can supply the same amount of drive current that would be available if high voltage devices and high voltage flying capacitors were used.

In addition, using the techniques of this disclosure, the charge pump can use a relatively low clock frequency to provide a drive current. By reducing the clock frequency, other circuits that are supplied by the charge pump can use less dynamic current (e.g., from switching), which, in turn, can reduce the oscillator block current.

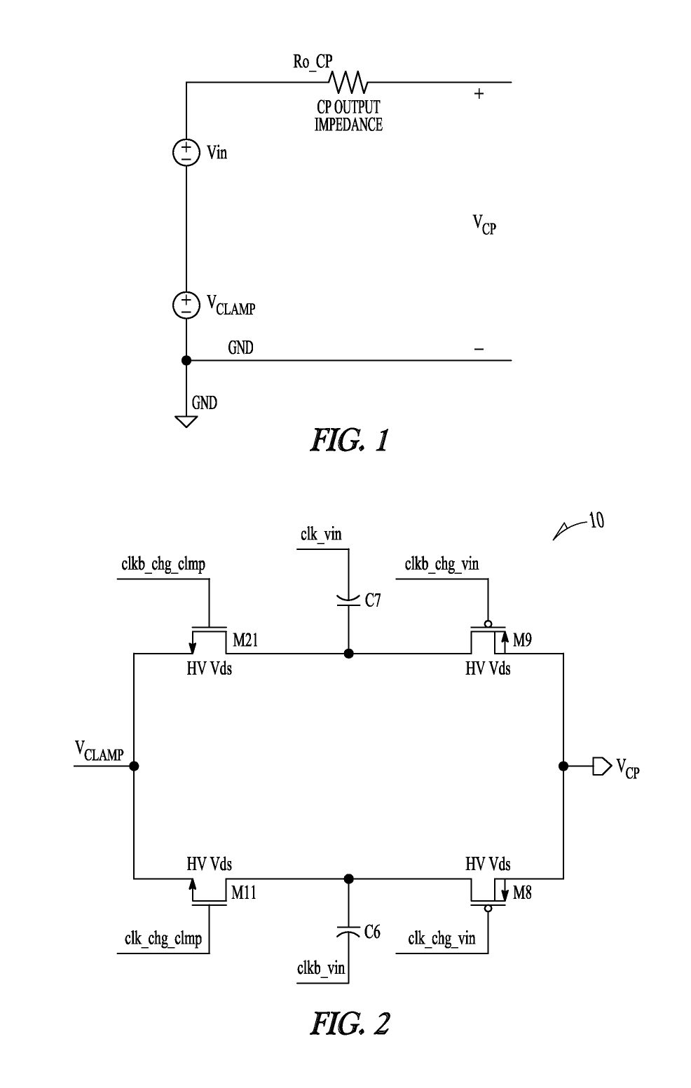

FIG. 1 is a circuit diagram illustrating an example Thevénin equivalent model of a charge pump. More particularly, FIG. 1 depicts two voltages, namely an input voltage (Vᵢₙ) in series with a peak-to-peak voltage of a clock (V_{clamp}) and a Thevénin equivalent output impedance of the charge pump (R_{o CP}).

The input voltage Vᵢₙ charges the flying capacitors (shown in FIG. 2) of the charge pump. In one example configuration of the charge pump of this disclosure, Vᵢₙ is between about 2.75 V and about 25 V, and V_{clamp} is between about 2.5 V and about 5.0 V. It should be noted that in one configuration, V_{clamp} is generated from Vᵢₙ, so if Vᵢₙ is at 2.75 V, for example, then V_{clamp} is also at 2.75 V.

The techniques of this invention are not limited to the particular ranges of voltages for Vᵢₙ and V_{clamp} indicated above. Rather, the lower and higher limits of the ranges of voltages for Vᵢₙ and V_{clamp} are for illustration purposes only and may be higher or lower than the ranges indicated above.

The Thevénin equivalent output impedance Rₒ_{_{—}}_{CP} can be estimated using Equation 1 below:

$${R}_{o\_CP} = \frac{1}{{f}_{clk} * {C}_{fly}} \qquad ( Eq . 1 )$$

where Rₒ_{_{—}}_{CP} is the Thevénin equivalent output impedance of the charge pump, f_{clk} is the frequency of the clock, and C_{fly} is the capacitance of the flying capacitor.

In order to provide a direct current (DC) sufficient to drive other circuits in electrical communication with the charge pump, Rₒ_{_{—}}_{CP} should be minimized, i.e., the product of f_{clk} and C_{fly} should be maximized. However, a balance must be struck between f_{clk} and C_{fly}.

In order to minimize the dynamic current consumed by the other circuits in electrical communication with the charge pump, f_{clk} can be limited. In addition, C_{fly} should not be too large because, as indicated above, high voltage capacitors can take up about ten times as much die area when compared to low voltage flying capacitors. Using various techniques of this disclosure, a charge pump design is disclosed in which a high input voltage can be increased from a first voltage to a second voltage, e.g., from 25 V to 30 V, with a reduced frequency and using low voltage flying capacitors, that is capable of supplying a DC drive current to the other components or circuits. The techniques of this disclosure reduce the amount of dynamic current from switching over existing designs, e.g., U.S. Pat. No. 6,995,602 to Pelliconi.

FIG. 2 is a circuit diagram illustrating an example charge pump 10 in accordance with various techniques of this disclosure. As described in more detail below, separate logic level shifted clock signals can be applied to each gate in the charge pump 10. In this manner, the charge pump 10 can operate using a high input supply voltage while also using low voltage FETs and low voltage flying capacitors. Using separate logic level shifted clock signals may also result in the charge pump supplying the same amount of drive current that would be available if high voltage devices and high voltage flying capacitors were used.

In an example, the charge pump 10 can include a plurality of field effect transistors (FETs), e.g., FETs M21, M9, M11, M8. Although the example charge pump 10 in FIG. 2 includes four FETs, other charge pump circuits may have more or less than four FETs. Further, although the FETs depicted in the example configuration shown in FIG. 2 are metal-oxide-semiconductor (MOS) FETs, the disclosure is not limited to the use of MOSFETs. For example, junction field-effect transistors (JFETs) or bipolar junction transistors (BJTs) can be used instead of or in combination with MOSFETs to form the charge pump 10.

In an example, the voltage at the output of the charge pump 10, namely V_{cp}, can be equal to the sum of the input voltage, Vᵢₙ, and the peak-to-peak voltage of the clock signal, V_{clamp} (i.e., V_{cp}=Vᵢₙ+V_{clamp}). In one example configuration, Vᵢₙ can include a voltage of 25 V and V_{clamp} can include a voltage of 5 V to provide V_{cp} equal to 30 V. Again, these voltages are example voltages and for purposes of illustration only.

FIG. 2 further depicts two flying capacitors C6, C7 configured to alternatingly charge and discharge in response to logic level shifted clock signal voltages applied to the charge pump 10, as described in more detail below. In this example, each of the flying capacitors C6, C7 is in electrical communication with at least one of the plurality of FETs. More particularly, in the example configuration depicted in FIG. 2, the flying capacitor C6 is electrically connected to each of FETs M21, M9, and the flying capacitor C7 is electrically connected to each of FETs M11, M8. Although FIG. 2 depicts two flying capacitors, in other configurations, more flying capacitors may be used.

As understood by one of ordinary skill in the art, each of FETs M21, M9, M11, M8 in the charge pump 10 can include a gate terminal, a drain terminal, and source terminal. In accordance with this disclosure, each respective gate terminal can be configured to receive a respective logic level shifted clock signal voltage or separate logic level shifted clock signals. Applying respective logic level shifted clock signal voltages to each respective gate terminal can limit the gate-source voltage (V_{gs}) for each of FETs M21, M9, M11, M8 to V_{clamp}, e.g., about 2.5 V to about 5 V.

As indicated above, high voltage gates are generally not desirable because they require additional masks, for example, that may not already be available in the circuit design. In addition, some FETs, e.g., CMOS FETs, with high voltage gates may have a high drain-source ON resistance that decreases the output voltage of the charge pump, thereby reducing the efficiency of the charge pump. Thus, by applying separate logic level shifted clock signals to each of the respective gate terminals of FETs M21, M9, M11, M8 of the charge pump 10, FETs with high voltage gates are not necessary. Instead, FETs with high voltage drains can be used, which are generally less expensive.

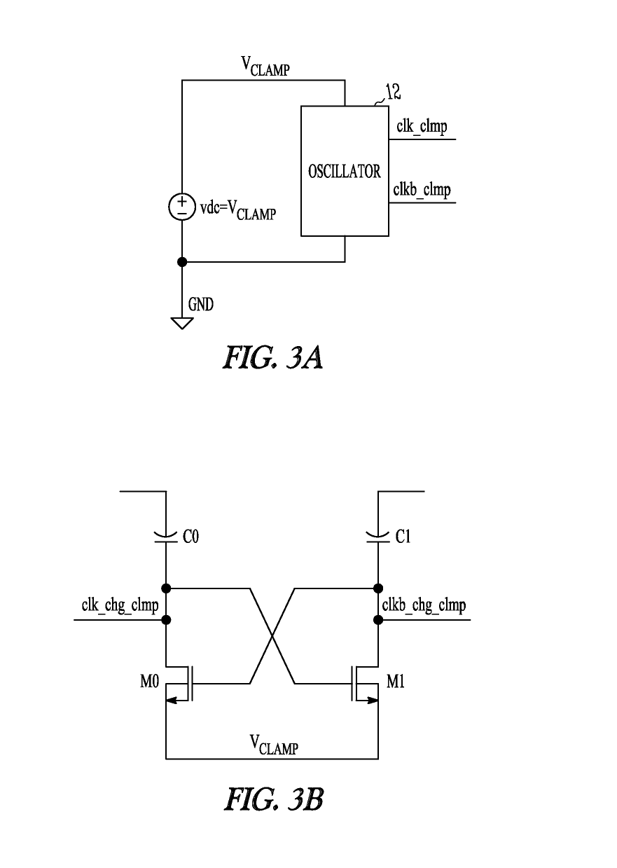

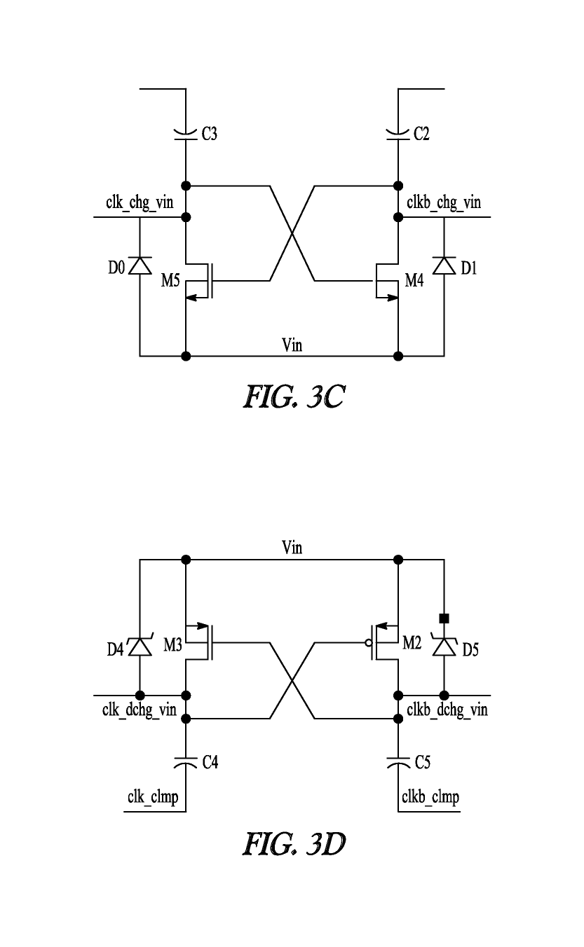

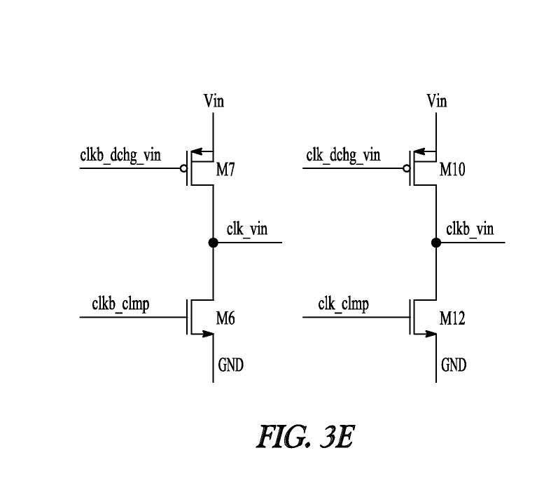

The application of respective logic level shifted clock signal voltages to each of the respective gate terminals of FETs M21, M9, M11, M8, as described in this disclosure, is in contrast to existing designs. For example, in FIG. 3 of U.S. Pat. No. 6,995,602 to Pelliconi, the gate terminals of transistor M1 and M2 are tied together and in electrical communication with flying capacitor TC2. Similarly, the gate terminals of transistor M3 and M4 are tied together and in electrical communication with flying capacitor TC1. Hence, the Pelliconi disclosure does not describe the application of respective logic level shifted clock signal voltages to each of the respective gate terminals of FETs M1-M4, such as that described in this disclosure.

Referring again to FIG. 2, assume that V_{clamp} is 5 V and Vᵢₙ is 25 V, each of which being a maximum value in one configuration of the charge pump 10. In accordance with this disclosure, a logic level shifted clock signal clk_chg_clmp applied to the gate terminal of FET M11 increases from a voltage of V_{clamp} (5 V) to a voltage of 2*V_{clamp} (10 V). As such, FET M11 of the charge pump 10 can have a maximum gate-source voltage of 5 V. Thus, in this example, FET M11 does not need a high voltage gate.

Referring to FET M8 (a p-type FET in one example configuration), a logic level shifted clock signal clk_chg_vin applied to the gate terminal of FET M8 increases from a voltage of Vᵢₙ (25 V) to a voltage of Vᵢₙ (25 V)+V_{clamp} (5 V), or 30 V. Ideally, V_{cp} is voltage Vᵢₙ (25 V)+V_{clamp} (5 V), or 30V. As such, FET M8 of the charge pump 10 can have a maximum gate-source voltage from −5 V to 0 V. Thus, in this example, FET M8 does not need a high voltage gate.

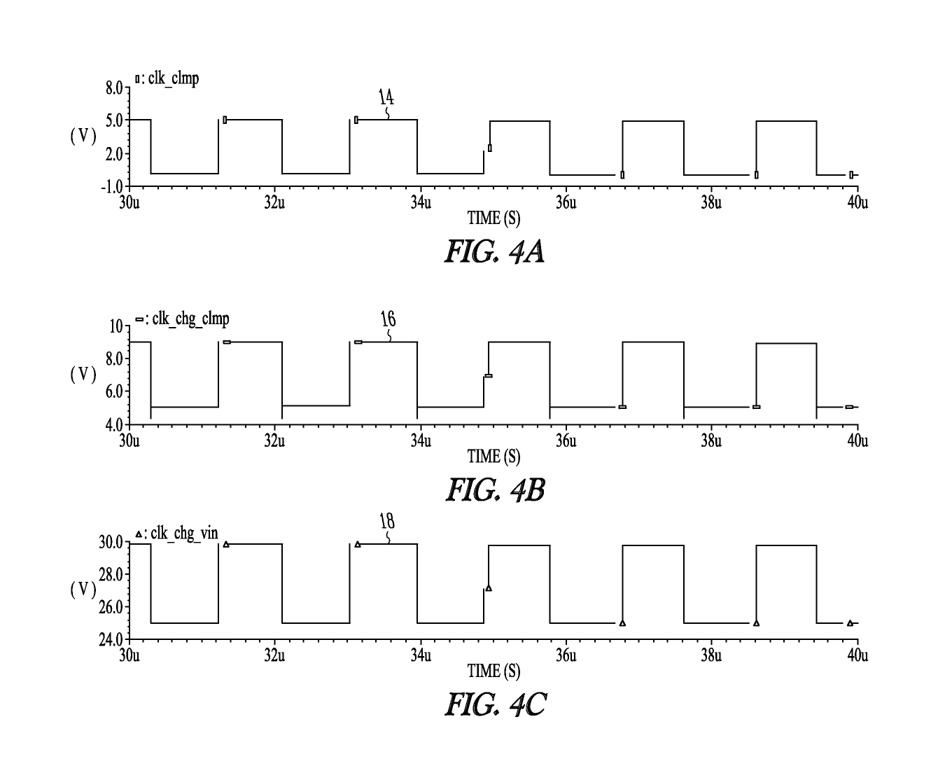

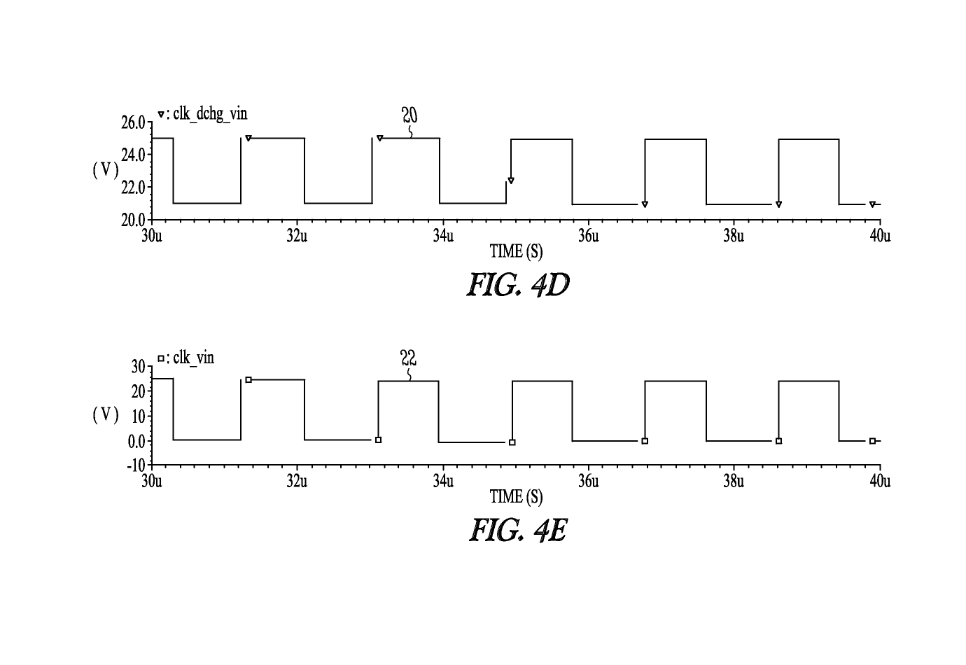

To be clear, in the example charge pump configuration depicted in FIG. 2, the logic level shifted clock signal voltage applied to the gate of FET M11 is different from the logic level shifted clock signal voltage applied to the gate of FET M8. As indicated above and as seen graphically in FIGS. 4B and 4C, the logic level shifted clock signal voltage clk_chg_clmp applied to the gate of FET M11 can include a first high voltage level (10 V) and first low voltage level (5 V), and clk_chg_vin applied to the gate of FET M8 has a second high voltage level (30 V) and second low voltage level (25 V). In one example, the second high voltage level of clk_chg_vin (30 V) is greater than the first high voltage level of clk_chg_clmp (10 V) and the second low voltage level of clk_chg_vin (25 V) is greater than the first low voltage level of clk_chg_clmp (5 V).

Of course, the voltages described above are one specific example configuration. The techniques of this disclosure are not limited to the specific voltages described above. Rather, the specific voltages described above are meant for illustration purposes only.

The gates of FETs M21, M9 can receive the inverted clock signals at the same logic levels applied to FETs M11, M8, respectively, e.g., if clk_chg_clmp increases from V_{clamp} to 2*V_{clamp}, the clkb_chg_clmp is the opposite (2*V_{clamp} decreases to V_{clamp}). As such, the gate-source voltages of FETs M21, M9 can be similar to that described above with respect to FETs M11, M8 and, for purposes of conciseness, will not be described again.

With respect to operation of the charge pump 10, a clock signals clk_vin, clkb_vin applied to the first and second flying capacitors C6, C7, respectively, alternate between a low level (0 V) and a high level Vᵢₙ (25 V). Clock signals clk_vin, clkb_vin are inversions of one another. During operation, if clk_vin is low (0 V), FET M21 is ON because clkb_chg_clmp is high. At this point, flying capacitor C6 will charge up to V_{clamp} (5 V).

Once clk_vin switches from low to high (25 V), FET M21 turns OFF because clkb_chg_clmp is low, and FET M9 turns ON because clkb_chg_vin is low. As clk_vin switches from low to a voltage of 25 V, there is now a 25 V source in series with flying capacitor C6, which was previously charged to 5 V. Hence, flying capacitor C6 will begin discharging and V_{cp} will be 30 V.

In the example configuration depicted in FIG. 2, FETs M11, M8 and flying capacitor C7 form a mirror image of FETs M21, M9 and flying capacitor C6. As FET M9 is ON and flying capacitor C6 is discharging, as described above, FET M8 is OFF, FET M11 is ON, and flying capacitor C7 is charging. That is, as one flying capacitor is charging, the other flying capacitor discharges, producing a drive current. In this manner, flying capacitors C6, C7 are configured to supply a voltage at the output of the charge pump 10 that is different from a voltage at the input of the charge pump 10. It should be noted that the flying capacitors of the charge pump 10 discharge if current is being drawn from the charge pump 10. If no current is being drawn from the charge pump 10, then the circuit alternates which flying capacitor is switched to V_{cp}, and the flying capacitor switched to V_{cp} does not discharge.

Because FETs M11, M8 and flying capacitor C7 form a mirror image of FETs M21, M9 and flying capacitor C6, the operation of FETs M21, M9 and flying capacitor C6 is similar to the operation described above with respect to FETs M21, M9 and flying capacitor C6. For purposes of conciseness, the operation of FETs M21, M9 and flying capacitor C6 will not be described in detail.

In the example configuration depicted in FIG. 2, FETs M21, M11 are n-type FETs and FETs M9, M8 are p-type FETs, resulting in a positive charge pump circuit with V_{cp} being greater than clk_vin. The techniques of this disclosure, however, are not so limited. Rather, in other example configurations, the techniques of this disclosure can produce a negative charge pump. For example, if FETs M21, M11 are p-type FETs and FETs M9, M8 are n-type FETs, then a negative charge pump circuit can be produced with V_{cp} being less than clk_vin.

In an example, the charge pump 10 of FIG. 2 can be incorporated into an integrated circuit (IC). For example, the charge pump circuit of FIG. 2 can form a portion of a larger IC that includes additional analog circuitry, e.g., comparators, operational amplifiers, etc. In one example configuration, the flying capacitors C6, C7 can be external to the IC. In such a case, the IC can have pins to connect to the external flying capacitors.

It should also be noted that the charge pump 10 of FIG. 2 may be a stand-alone charge pump. In another example configuration, V_{cp} can be applied to the input of a second charge pump, configured as in FIG. 2 or configured in some other manner. In this manner, two or more charge pumps may be placed in series with one another. As two or more charge pumps are placed in series together, however, the output impedances begin to add, so to supply the same amount of drive current, the circuit may need to be operated at a higher frequency or with flying capacitors with a higher capacitance.

FIG. 3A-3E are circuit diagrams illustrating example circuits that are used to dynamically shift the logic level of a clock signal, in accordance with various techniques of this disclosure. Using the techniques of this disclosure, separate logic level shifted clocks are generated by the circuits depicted in FIGS. 3A-3E and applied to a respective gate of the FETs in a charge pump 10, thereby limiting the gate-source voltage of the FETs in the charge pump 10 to V_{clamp} (e.g., 5 V). In certain examples, the logic level shifted clock generation circuits depicted in FIGS. 3A-3E do not drive a DC load and can therefore be small.

FIG. 3A depicts an oscillator circuit configured to generate two clock signals that are used by the circuits of FIGS. 3B-3E for logic level shifted clock generation. More particularly, FIG. 3A depicts an oscillator 12, supplied by a DC voltage V_{clamp}, that generates first and second clock signals clk_clmp, clkb_clmp. First and second clock signals clk_clmp, clkb_clmp can alternate between 0 V and 5 V and have opposite polarities. The oscillator 12 of FIG. 3A can generate two clock signals that are then level shifted by the circuits shown and described below with respect to FIGS. 3B-3E.

FIGS. 3B-3E depict logic level shifting circuits that are, generally speaking, configured to increase the voltage of each of the first clock signal voltage and the second clock signal voltage of the oscillator 12 of FIG. 3A, and generate the respective logic level shifted clock signal voltages that are applied to each of the respective gate terminals of the FETs in the charge pump 10 of FIG. 2.

FIG. 3B depicts a logic level shifting circuit including capacitors C0, C1 and FETs M0, M1 used to generate the logic level shifted clock signals applied to the gate terminals of FETs M21, M11 of the charge pump 10 of FIG. 2. More particularly, FIG. 3B depicts a half charge pump circuit that can increase V_{clamp} to 2*V_{clamp}. The capacitors shown in FIG. 3B, namely capacitors C0, C1, can be small because they are used to provide a bias voltage to the gate terminals of FETs M21, M11 of the charge pump 10 of FIG. 2 and do not need to produce a DC drive current.

In operation, if clk_clmp is high (e.g., 5 V), clkb_clmp is low (e.g., 0 V), FET M1 is ON, and flying capacitor C1 charges to V_{clamp}, e.g., to 5 V. If clk_clmp is low (e.g., 0 V), clkb_clmp is high (e.g., 5 V), FET M0 is ON, and flying capacitor C0 charges to V_{clamp}, e.g., to 5 V. In the next clock cycle, FET M1 is ON and flying capacitor C1 (charge to V_{clamp}) is in series with V_{clamp} and clkb_chg_clmp is now 2* V_{clamp} (e.g., 10 V). Similarly, in the following clock cycle, FET M0 is ON and flying capacitor C0 (charge to V_{clamp}) is in series with V_{clamp} and clk_chg_clmp is now 2*V_{clamp} (e.g., 10 V).

In the example circuit shown in FIG. 3B, FETs M0, M1 are depicted as n-type MOSFETs. In some examples, FETs M0, M1 are p-type MOSFETs.

FIG. 3C depicts a logic level shifting circuit that is used to generate the logic level shifted clock signals applied to the gate terminals of FETs M9, M8 of the charge pump 10 of FIG. 2. More particularly, FIG. 3C depicts a half charge pump circuit that includes FETs M4, M5 and flying capacitors C2, C3 and that increases voltage Vᵢₙ to (Vᵢₙ+V_{clamp}) to generate logic level shifted clock signals clk_chg_vin and clkb_chg_vin, which are opposite in polarity to one another.

The operation of the clock signal generation circuit of FIG. 3C is similar to the operation of the circuit described above with respect to FIG. 3B and, as such, will not be described in detail. One notable difference is that in FIG. 3C, Vᵢₙ (e.g., 25 V), not V_{clamp}, is being added in series with a flying capacitor, e.g., flying capacitor C3, charged to V_{clamp} (e.g., 5V). Thus, in one example configuration, clk_chg_vin and clkb_chg_vin alternate between 25 V and 30 V.

Unlike the flying capacitors depicted in the example circuit shown in FIG. 3B, flying capacitors C2, C3 of FIG. 3C must be high voltage capacitors to operate between about 25 V and about 30 V. However, flying capacitors C2, C3 can physically be small (and thus take up little die area) because they are not required to drive any other devices.

In addition, the logic level shifting generation circuit of FIG. 3C includes diodes D0, D1. Diodes D0, D1 are used to limit the device gate-source voltage of FETs M4, M5 during a ramp up of Vᵢₙ. That is, diodes D0, D1 are used so that if Vᵢₙ ramps up quickly and the charge pump 10 of FIG. 2 has not yet started operating, diodes D0, D1 will break down at about 0.7 V and protect the gate bias of each FET. Once the charge pump 10 starts running, then clock signal clk_chg_vin (similarly, clock signal clkb_chg_vin) should always be equal to or greater than Vᵢₙ, so diodes D0, D1 will always be open.

FIG. 3D depicts a logic level shifting circuit that is used to generate the logic level shifted clock signals applied to FETs M7, M10 in FIG. 3E for generation of logic level shifted clock signals clk_vin and clkb_vin. More particularly, FIG. 3D depicts a half charge pump circuit that includes FETs M2, M3 and flying capacitors C4, C5, and that increases voltage (Vᵢₙ−V_{clamp}) to Vᵢₙ to generate logic level shifted clock signals clk_dchg_vin and clkb_dchg_vin, which are opposite in polarity to one another. The operation of the logic level shifting circuit in FIG. 3D is similar to that described above with respect to FIG. 3B and, for the purposes of conciseness, will not be described.

Unlike the flying capacitors depicted in the example circuit shown in FIG. 3B, flying capacitors C4, C5 of FIG. 3D must be high voltage capacitors because flying capacitors C4, C5 are charging to (Vᵢₙ−V_{clamp}), e.g., (25 V−5 V, or 20 V to operate at 25 V−30 V). However, flying capacitors C4, C5 can physically be small (and take up little die area) because they are not required to drive any other devices.

In addition, the clock signal generation circuit of FIG. 3D includes zener diodes D4, D5. Zener diodes D4, D5 can be used to limit the device gate-source voltage of FETs M2, M3 during a ramp up of Vᵢₙ. That is, zener diodes D4, D5 are used so that if Vᵢₙ ramps up quickly and the charge pump 10 of FIG. 2 has not yet started operating, zener diodes D4, D5 will break down and protect the gate bias of each FET. Zener diodes D4, D5 should break down at about −5 V (instead of at 0.7 V) because the clock voltage is no more than 5 V below Vᵢₙ. Once the charge pump 10 starts running, clock signal clk_dchg_vin (similarly, clock signal clkb_dchg_vin) will always be equal to or less than Vᵢₙ, so zener diodes D4, D5 will always be open.

It should be noted that FETs M2, M3 of FIG. 3D are depicted as p-type FETs. In some example configurations, FETs M2, M3 of FIG. 3D may be n-type MOSFETs.

FIG. 3E depicts a logic level shifting circuit that is used to generate the logic level shifted clock signals applied to flying capacitors C6, C7 of the charge pump 10 (FIG. 2). In the example configuration shown in FIG. 3E, a first pair of FETs, namely FETs M6, M7, are electrically coupled together. More particularly, the drain terminal of n-type FET M6 is electrically connected to the drain terminal of p-type FET M7, thereby forming a first inverter that generates clock signal clk_vin, which is applied to flying capacitor C6 of the charge pump 10 of FIG. 2.

Similarly, a second pair of FETs, namely FETs M10, M12, are electrically coupled together. More particularly, the drain terminal of n-type FET M12 is electrically connected to the drain terminal of p-type FET M10, thereby forming a second inverter that generates clock signal clkb_vin, which is applied to flying capacitor C7 of the charge pump 10 of FIG. 2. Logic level shifted clock signals clk_vin and clkb_vin are opposite in polarity to one another.

It should be noted that in classic FET inverter configurations, the drains of two FETs are shorted together and the gates of the two FETs are shorted together. Although the gates of the FETs are not shorted together in either of the first or second inverter configuration described above with respect to FIG. 2, the configurations described in FIG. 2 still operate functionally as inverters.

Referring to the first inverter formed by FETs M6, M7 on the left-hand side of FIG. 3E, clock signal clkb_clmp (from the oscillator circuit shown in FIG. 3A), which is applied to the gate of FET M6, switches between 0 V and V_{clamp} in order to turn FET M6 OFF and ON, respectively. Clock signal clkb_dchg_vin, which is applied to the gate of FET M7, switches from Vᵢₙ to (Vᵢₙ−V_{clamp}) to turn FET M7 ON and OFF, respectively. In this manner, the first inverter formed by FETs M6, M7 generates a clock signal clk_vin that alternates between 0 V and Vᵢₙ, e.g., 25 V. Clock signal clk_vin is applied to flying capacitor C6 of the charge pump 10 of FIG. 2.

It should be noted that because the gate-source voltage of FETs M6, M7 is never greater than V_{clamp}, e.g., 5 V, FETs M6, M7 do not require high voltage gates. However, because the clock signal alternates between 0 V and Vᵢₙ, e.g., 25 V, the maximum drain-source voltage (V_{ds}) of FETs M6, M7 will be equal to Vᵢₙ, e.g., 25 V. Thus, high voltage V_{ds} devices should be used for FETs M6, M7.

Second inverter formed by FETs M10, M12 is a mirror image of the first inverter described above and, as such, operates in a similar manner. For purposes of conciseness, the operation of the second inverter formed by FETs M10, M12 will not be described.

In this manner, the circuits depicted in FIGS. 3A-3E are used to generate logic level shift clock signals that, in turn, are applied to respective gates in the charge pump 10 of FIG. 2. By dynamically shifting the logic level of the clock signal using the techniques described in this disclosure, the use of high voltage flying capacitors and the use of devices with high voltage gates are avoided and the size of the charge pump can be reduced over existing charge pump techniques.

FIGS. 4A-4E depict various example logic level shifted clock signals generated by the example circuits depicted in FIGS. 3A-3E. In FIGS. 4A-4E, the x-axes represent time in seconds and the y-axes represent the clock signal voltage in volts. It should be noted that all of the clock signals depicted in FIGS. 4A-4E are in phase with each other. That is, the clock signals shown in FIGS. 4A-4E switch voltage levels (i.e., transition from a high logic level to a low logic level) at substantially the same time because the signals are generated by the same clock and then level shifted.

FIG. 4A depicts a clock signal clk_clmp, shown at 14 and generated by the circuit shown in FIG. 3A, alternating between 0 V and 5 V (V_{clamp}). FIG. 4B depicts a clock signal clk_chg_clmp, shown at 16 and generated by the circuit shown in FIG. 3B, alternating between 5 V (V_{clamp}) and 10 V (2*V_{clamp}). FIG. 4C depicts a clock signal clk_chg_vin, shown at 18 and generated by the circuit shown in FIG. 3C, alternating between 25 V (Vᵢₙ) and 30 V (Vᵢₙ+V_{clamp}). FIG. 4D depicts a clock signal clk_dchg_vin, shown at 20 and generated by the circuit shown in FIG. 3D, alternating between 20 V (Vᵢₙ−V_{clamp}) and Vᵢₙ (25 V). FIG. 4E depicts a clock signal clk_vin, shown at 20 and generated by the circuit shown in FIG. 3E, alternating between 0 V and Vᵢₙ (25 V).

### ADDITIONAL NOTES AND EXAMPLES

In Example 1, an integrated circuit comprises a charge pump circuit comprising an input, an output, a plurality of field effect transistors (FETs), each of the plurality FETs having a respective gate terminal, and at least two flying capacitors in electrical communication with at least one of the plurality of FETs, wherein each of the respective gate terminals is configured to receive a respective logic level shifted clock signal voltage, wherein the at least two flying capacitors are configured to alternatingly charge and discharge in response to the logic level shifted clock signal voltages, and wherein the at least two flying capacitors are configured to supply a voltage at the output that is different from a voltage at the input.

In Example 2, the plurality of FETs in the integrated circuit of Example 1 are optionally configured to comprise a first pair of FETs arranged as a first inverter, and a second pair of FETs arranged as a second inverter, wherein each of the FETs of the first pair have a respective drain terminal, wherein each of the respective drain terminals of the first pair of FETs are in electrical communication with each other and with a terminal of one of the flying capacitors, and wherein each of the FETs of the second pair have a respective drain terminal, wherein each of the respective drain terminals of the second pair of FETs are in electrical communication with each other and with a terminal of another of the flying capacitors.

In Example 3, each of the first pair of FETs and the second pair of FETs in the integrated circuit of any one or more of Examples 1-2 is optionally configured as a complimentary metal-oxide-semiconductor (CMOS) inverter.

In Example 4, the charge pump circuit of the integrated circuit of any one or more of Examples 1-3 is optionally configured as a positive charge pump circuit configured to receive an input voltage and to provide an output voltage greater than the input voltage.

In Example 5, the charge pump circuit of the integrated circuit of any one or more of Examples 1-4 is optionally configured as a negative charge pump circuit configured to receive an input voltage and to provide an output voltage less than the input voltage.

In Example 6, the integrated circuit of any one or more of Examples 1-5 optionally includes an oscillator circuit configured to generate a first clock signal voltage and a second clock signal voltage, and at least two logic level shifting circuits. The at least two logic level shifting circuits are configured to increase the voltage of each of the first clock signal voltage and the second clock signal voltage, and generate the respective logic level shifted clock signal voltages that are applied to each of the respective gate terminals.

In Example 7, the respective logic level shifted clock signal voltages of the integrated circuit of any one or more of Examples 1-6 are optionally in phase with one another.

In Example 8, the respective logic level shifted clock signal voltages of the integrated circuit of any one or more of Examples 1-7 optionally comprise first and second logic level shifted clock signal voltages, wherein the respective logic level shifted clock signal voltages comprise first and second logic level shifted clock signal voltages, wherein the first logic level shifted clock signal voltage has a first high voltage level and first low voltage level, wherein the second logic level shifted clock signal voltage has a second high voltage level and a second low voltage level, and wherein the second high voltage level is greater than the first high voltage level and the second low voltage level is greater than the first low voltage level.

In Example 9, a charge pump circuit comprises an input, an output, a plurality of field effect transistors (FETs), each of the plurality FETs having a respective gate terminal, and at least two flying capacitors in electrical communication with at least one of the plurality of FETs, wherein each of the respective gate terminals is configured to receive a respective logic level shifted clock signal voltage, wherein the at least two flying capacitors are configured to alternatingly charge and discharge in response to the logic level shifted clock signal voltages, and wherein the at least two flying capacitors are configured to supply a voltage at the output that is different from a voltage at the input.

In Example 10, the plurality of FETs in the charge pump circuit of any one or more of Examples 1-9 optionally comprise a first pair of FETs arranged as a first inverter, and a second pair of FETs arranged as a second inverter, wherein each of the FETs of the first pair have a respective drain terminal, wherein each of the respective drain terminals of the first pair of FETs are in electrical communication with each other and with a terminal of one of the flying capacitors, and wherein each of the FETs of the second pair have a respective drain terminal, wherein each of the respective drain terminals of the second pair of FETs are in electrical communication with each other and with a terminal of another of the flying capacitors.

In Example 11, each of the first pair of FETs and the second pair of FETs in the charge pump circuit of any one or more of Examples 1-10 is optionally configured as a complimentary metal-oxide-semiconductor (CMOS) inverter.

In Example 12, the charge pump circuit of any one or more of Examples 1-11 optionally includes a positive charge pump circuit configured to receive an input voltage and to provide an output voltage greater than the input voltage.

In Example 13, the charge pump circuit of any one or more of Examples 1-12 optionally includes a negative charge pump circuit configured to receive an input voltage and to provide an output voltage less than the input voltage.

In Example 14, the charge pump circuit of any one or more of Examples 1-13 optionally includes an oscillator circuit configured to generate a first clock signal voltage and a second clock signal voltage, and at least two logic level shifting circuits. The at least two logic level shifting circuits are configured to increase the voltage of each of the first clock signal voltage and the second clock signal voltage, and generate the respective logic level shifted clock signal voltages that are applied to each of the respective gate terminals.

In Example 15, the respective logic level shifted clock signal voltages of the charge pump circuit of any one or more of Examples 1-14 are optionally in phase with one another.

In Example 16, the respective logic level shifted clock signal voltages of the charge pump circuit of any one or more of Examples 1-15 optionally comprise first and second logic level shifted clock signal voltages, wherein the first logic level shifted clock signal voltage has a first high voltage level and first low voltage level, wherein the second logic level shifted clock signal voltage has a second high voltage level and a second low voltage level, and wherein the second high voltage level is greater than the first high voltage level and the second low voltage level is greater than the first low voltage level.

In Example 17, a method for generating a boosted voltage at a charge pump circuit output comprises generating a plurality of logic level shifted clock signal voltages, applying the plurality of logic level shifted clock signal voltages, respectively, to a plurality of gate terminals of a plurality of field effect transistors (FETs), and alternatingly charging and discharging at least two flying capacitors in electrical communication with the plurality of FETs in response to the different clock signal voltages, wherein the at least two flying capacitors are configured to supply a boosted voltage at the output of the charge pump circuit.

In Example 18, the plurality of FETs of any one or more of Examples 1-17 optionally comprise a first pair of FETs arranged as a first inverter, and a second pair of FETs arranged as a second inverter, wherein each of the FETs of the first pair have a respective drain terminal, wherein each of the respective drain terminals of the first pair of FETs are in electrical communication with each other and with a terminal of one of the flying capacitors, and wherein each of the FETs of the second pair have a respective drain terminal, wherein each of the respective drain terminals of the second pair of FETs are in electrical communication with each other and with a terminal of another of the flying capacitors.

In Example 19, each of the first pair of FETs and the second pair of FETs in any one or more of Examples 1-18 is optionally configured as a complimentary metal-oxide-semiconductor (CMOS) inverter.

In Example 20, the charge pump circuit of any one or more of Examples 1-19 optionally includes a positive charge pump circuit configured to receive an input voltage and to provide an output voltage greater than the input voltage.

In Example 21, the charge pump of any one or more of Examples 1-19 optionally includes a negative charge pump circuit configured to receive an input voltage and to provide an output voltage less than the input voltage.

In Example 22, the generating a plurality of different clock signal voltages of any one or more of Examples 1-21 optionally comprises generating a first clock signal voltage and a second clock signal voltage, and increasing the voltage of each of the first clock signal voltage and the second clock signal voltage to generate the logic level shifted clock signal voltages that are applied, respectively, to the plurality of gate terminals of the plurality of FETs.

In Example 23, a charge pump circuit comprises means for generating a plurality of logic level shifted clock signal voltages, means for applying the plurality of logic level shifted clock signal voltages, respectively, to a plurality of gate terminals of a plurality of field effect transistors (FETs), and means for alternatingly charging and discharging at least two flying capacitors in electrical communication with the plurality of FETs in response to the different clock signal voltages, wherein the at least two flying capacitors are configured to supply a boosted voltage at the output of the charge pump circuit.

In Example 24, a system or apparatus can include, or can optionally be combined with any portion or combination of any portions of any one or more of Examples 1-23 to include, means for generating a plurality of logic level shifted clock signal voltages, means for applying the plurality of logic level shifted clock signal voltages, respectively, to a plurality of gate terminals of a plurality of field effect transistors (FETs), and means for alternatingly charging and discharging at least two flying capacitors in electrical communication with the plurality of FETs in response to the different clock signal voltages, wherein the at least two flying capacitors are configured to supply a boosted voltage at the output of the charge pump circuit.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A charge pump circuit comprising:
an input;
an output;
a plurality of field effect transistors (FETs), each of the plurality FETs having a respective gate terminal; and
at least two flying capacitors in electrical communication with at least one of the plurality of FETs,
wherein each of the respective gate terminals is configured to receive a respective logic level shifted clock signal voltage,
wherein the at least two flying capacitors are configured to alternatingly charge and discharge in response to the logic level shifted clock signal voltages, and
wherein the at least two flying capacitors are configured to supply a voltage at the output that is different from a voltage at the input.

2. The charge pump circuit of claim 1, wherein the plurality of FETs comprises:
a first pair of FETs arranged as a first inverter; and
a second pair of FETs arranged as a second inverter,
wherein each of the FETs of the first pair have a respective drain terminal, wherein each of the respective drain terminals of the first pair of FETs are in electrical communication with each other and with a terminal of one of the flying capacitors, and
wherein each of the FETs of the second pair have a respective drain terminal, wherein each of the respective drain terminals of the second pair of FETs are in electrical communication with each other and with a terminal of another of the flying capacitors.

3. The charge pump circuit of claim 2, wherein each of the first pair of FETs and the second pair of FETs is configured as a complimentary metal-oxide-semiconductor (CMOS) inverter.

4. The charge pump circuit of claim 1, wherein the charge pump circuit includes a positive charge pump circuit configured to receive an input voltage and to provide an output voltage greater than the input voltage.

5. The charge pump circuit of claim 1, wherein the charge pump includes a negative charge pump circuit configured to receive an input voltage and to provide an output voltage less than the input voltage.

6. The charge pump circuit of claim 1, further comprising:
an oscillator circuit configured to generate a first clock signal voltage and a second clock signal voltage; and
at least two logic level shifting circuits configured to:
increase the voltage of each of the first clock signal voltage and the second clock signal voltage; and
generate the respective logic level shifted clock signal voltages that are applied to each of the respective gate terminals.

7. The charge pump circuit of claim 1, wherein the respective logic level shifted clock signal voltages are in phase with one another.

8. The charge pump circuit of claim 1,
wherein the respective logic level shifted clock signal voltages comprise first and second logic level shifted clock signal voltages,
wherein the first logic level shifted clock signal voltage has a first high voltage level and first low voltage level,
wherein the second logic level shifted clock signal voltage has a second high voltage level and a second low voltage level, and
wherein the second high voltage level is greater than the first high voltage level and the second low voltage level is greater than the first low voltage level.

9. The charge pump circuit of claim 1, further comprising:
an integrated circuit including the charge pump circuit.

10. An integrated circuit consisting of:
a charge pump circuit comprising:
an input;
an output;
a plurality of field effect transistors (FETs), each of the plurality FETs having a respective gate terminal,
wherein each of the respective gate terminals is configured to receive a respective logic level shifted clock signal voltage,
wherein at least two flying capacitors in electrical communication with at least one of the plurality of FETs are configured to alternatingly charge and discharge in response to the logic level shifted clock signal voltages, and
wherein the at least two flying capacitors are configured to supply a voltage at the output that is different from a voltage at the input.

11. A method for generating a boosted voltage at a charge pump circuit output, the method comprising:
generating a plurality of logic level shifted clock signal voltages;
applying the plurality of logic level shifted clock signal voltages, respectively, to a plurality of gate terminals of a plurality of field effect transistors (FETs); and
alternatingly charging and discharging at least two flying capacitors in electrical communication with the plurality of FETs in response to the different clock signal voltages,
wherein the at least two flying capacitors are configured to supply a boosted voltage at the output of the charge pump circuit.

12. The method of claim 11, wherein the plurality of FETs comprises:
a first pair of FETs arranged as a first inverter; and
a second pair of FETs arranged as a second inverter,
wherein each of the FETs of the first pair have a respective drain terminal, wherein each of the respective drain terminals of the first pair of FETs are in electrical communication with each other and with a terminal of one of the flying capacitors, and
wherein each of the FETs of the second pair have a respective drain terminal, wherein each of the respective drain terminals of the second pair of FETs are in electrical communication with each other and with a terminal of another of the flying capacitors.

13. The method of claim 12, wherein each of the first pair of FETs and the second pair of FETs is configured as a complimentary metal-oxide-semiconductor (CMOS) inverter.

14. The method of claim 11, wherein the charge pump circuit includes a positive charge pump circuit configured to receive an input voltage and to provide an output voltage greater than the input voltage.

15. The method of claim 11, wherein the charge pump includes a negative charge pump circuit configured to receive an input voltage and to provide an output voltage less than the input voltage.

16. The method of claim 11, wherein generating a plurality of different clock signal voltages comprises:
generating a first clock signal voltage and a second clock signal voltage; and
increasing the voltage of each of the first clock signal voltage and the second clock signal voltage to generate the logic level shifted clock signal voltages that are applied, respectively, to the plurality of gate terminals of the plurality of FETs.
